(19) United States
(12) Patent Application Publication
(10) Pub. No.: US 2003/0074246 A1
(43) Pub. Date: Apr. 17, 2003

(54) Method and architecture for automated discovery provisioning of a broadband communication network

(76) Inventors: Keven M. Adams, Duluth, GA (US); Robin P. Helms, Woodstock, GA (US); Alan Skinner, Tucker, GA (US); Robert Eng, Alpharetta, GA (US)

Correspondence Address: ARRIS INTERNATIONAL, INC, 11450 TECHNOLOGY CIRCLE, DULUTH, GA, 30097, US

(21) Appl. No.: 10/269,352

(22) Filed: Oct. 11, 2002

Related U.S. Application Data
(60) Provisional application No. 60/328,657, filed on Oct. 11, 2001.

(51) Int. Cl. G06F 17/60

(52) U.S. Cl. 705/8; 705/9

(57) ABSTRACT

Automatically detecting a network interface unit in a broadband communications network and sending an electronic serial number associated with the NIU to a central host digital terminal for automatically provisioning desired services. Upon receipt of the ESN, the host digital terminal issues a special call reference number that corresponds to a soft dial tone channel established between the HDT and the NIU. A field technician enters a work order number from the NIU over the soft dial tone channel, the work order work order number corresponding to the desired services. The HDT automatically associates the desired services with the NIU, because the work order number was received from the soft dial tone channel that corresponds to the special call reference number, which in turn corresponds to the NIU. The special call reference value is replaced with a permanent call reference value, thus provisioning the NIU.

### CROSS REFERENCE TO RELATED APPLICATION

This application claims the benefit of priority under 35 U.S.C. 119(e) to the filing date of Adams, et al., U.S. provisional patent application No. 60/328,657 entitled “Method And Architecture For Automated Discovery Provisioning Of A Broadband Communication Network”, which was filed Oct. 11, 2001, and is incorporated herein by reference.

### FIELD OF INVENTION

This invention relates, generally, to broadband communication networks and, more particularly, to the provisioning thereof due to new subscribers.

### BACKGROUND OF THE INVENTION

Broadband communication networks, such as hybrid fiber coax networks, provide communication services to subscribers. When a new subscriber desires this service, the network has to be appropriately provisioned in order for the network to accommodate the subscriber and the subscriber to access and use the service. The provisioning can take an appreciable amount of time and effort. Therefore, there is a period between the time the subscriber orders the service from the service provider and the time the service provider can activate the service and make it available for the subscriber's use.

There are currently two key factors which create problems and delays in broadband network provisioning: first, broadband network database inaccuracy and, second, human error. Broadband service providers maintain databases that map a potential subscriber's address to a given node in its distribution network. Accuracy in the databases is important because a given node is served by a specific telephony host digital terminal (“HDT”). Most service providers, such as cable operators, currently prefer to pre-provision their service orders. This means that all ordered lines are programmed into the host digital terminal using a placeholder prior to the actual day of installation. This process is susceptible to inaccuracies in the databases that may range as high as 30%, thereby indicating the wrong node association for many addresses. This, then, requires a time consuming review to determine the correct node/address association. Although portions of the current provisioning process are automated, all activity occurring on the day of installation is still manual. The installer must interface with another support technician to perform the correlation between the actual network interface unit (“NIU”) and the provisioning assigned to the placeholder. There are, therefore, many communication and data entry problems associated with the current provisioning process along with its inherent inefficiencies.

Solutions to these problems involved trying to improve the accuracy of the databases. This involves, though, technician walk-outs, in which a technician roams the boundaries between nodes in a distribution network and transmits indicator signals back to other technicians waiting at the origination point, or “head-end.” Walk-outs, though, are expensive, time consuming and, typically, do not provide a large improvement in database accuracy.

A need exists, therefore, for a method and architecture for provisioning broadband communication networks that are not subject to errors in databases and can be efficiently performed with limited manual activity.

### SUMMARY OF THE INVENTION

The present invention is a method and architecture to satisfy the aforementioned need.

Accordingly, the present invention is directed to an architecture for provisioning a new subscriber in a broadband communication network comprising a network interface unit associated with the subscriber and having a unique identification number, electronic serial number (“ESN”), an operational support system which automatically identifies the network interface unit based on the electronic serial number, and a soft dial tone provisioned by the operational support system to the network interface unit such that the soft dial tone is used by a technician to automatically provision the network interface unit.

In another aspect, the present invention is directed to a method for provisioning a new subscriber in a broadband communication network. An electronic serial number is sent from a network interface unit, thereby automatically identifying the network interface unit to a host digital terminal. Soft dial tone is provided to the network interface unit. A special call reference value is assigned to the soft dial tone channel so that when a technician enters a work order number, which corresponds to a subscriber's requested services, the host digital terminal can associate the network interface unit with the requested services. Equipment at a network operator's facilities determines a permanent call reference value based on availability at a network switch, and replaces the special call reference value with the permanent call reference value, thereby provisioning the network interface unit with the requested services

### BRIEF DESCRIPTION OF THE DRAWINGS

FIG. 1 is a block diagram of a portion of a broadband communication network in which the auto-discovery provisioning architecture of the present invention is included.

FIG. 2 is a flowchart illustrating the logical steps in a traditional customer request service process.

FIG. 3 is a flowchart illustrating the logical steps of an embodiment of the auto-discovery provisioning method of the present invention.

FIGS. 4A, 4B, 4C, 4D, 4E, and 4F are flowcharts illustrating the logical steps of another embodiment of the auto-discovery provisioning method of the-present invention.

FIG. 5 is a network topology block diagram illustrating the flow and temporal relationship of information messages.

### DETAILED DESCRIPTION OF THE PREFERRED EMBODIMENTS

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

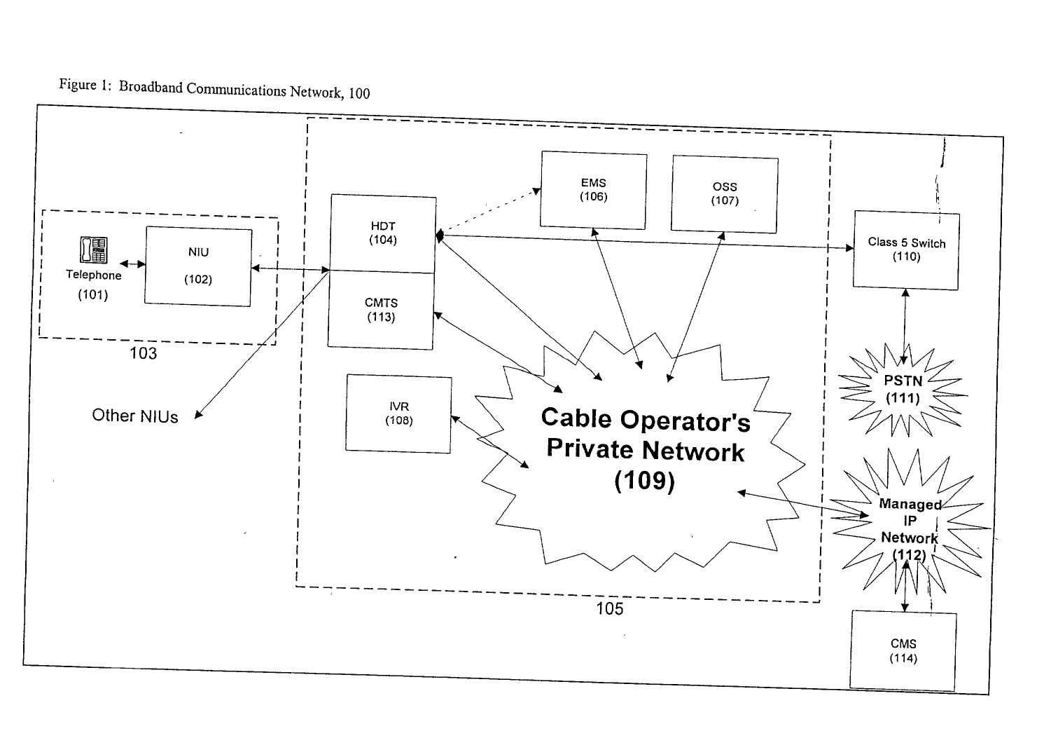

Referring now to FIG. 1, there is shown a block diagram portion of a broadband communication network 100 with the auto-discovery provisioning architecture of an embodiment of the present invention. The telephony equipment 101 and the network interface unit (“NIU”) 102 are located at the subscriber's premises 103. The network interface unit 102 can be a cable modem or any other portal device used to interface the telephony equipment 101 to the broadband communications network 100. The portal device may provide such interface for voice signals transmitted over the traditional Public Switched Telephone Network 111 or the Managed IP Network 112. Such portal devices may include a VOICE PORT™ or EMTA as provided by ARRIS International, Inc. The network interface unit 102 connects to the broadband communication network 100 through the host digital terminal host digital terminal 104 and/or a cable modem termination system (“CMTS”) 113 to the cable operator's private network 109, which can be a local area network. The host digital terminal 104 and the CMTS 113 may be incorporated into a Converged Host Terminal (“CHT”). Although, in FIG. 1, the service provider is shown as a cable operator, the invention is not limited thereto and those of ordinary skill in the art will appreciate that the present invention applies to any type of communication service provider. The host digital terminal 104 and CMTS 113 are located at the cable operator's facility 105 and provide the necessary interface functions between the broadband communication network 100 and network interface unit 102 and telephony equipment 101. Multiple network interface unit's 102 can be connected to one host digital terminal 104 or CMTS 113. Different software and/or hardware including an element management system 106, operational support system 107, and provisioning center/integrated voice response unit (“IVR”) 108 monitor and control the operation the broadband communication network 100 and provide and support the functions delivered to a subscriber. The cable operator's private network connects either to a Class 5 switch 110 or directly to the Managed IP Network 112. The Class 5 switch connects the cable operator to the Public Switched Telephone Network 111 over which voice and data communication is transmitted. The Managed IP Network 112 transmits data or Voice over Internet Protocol (“VoIP”) signals.

Upon the addition of a new subscriber to the broadband communication network 100, a network interface unit 102 for that subscriber is installed at the customer premises 101. Once installed, the appropriate host digital terminal 104 detects the network interface unit 102. For simplicity, further references to host digital terminal 104 are intended to include references to an host digital terminal 104, a CMTS 113 or a CHT. Element management system 106 then notifies the operational support system 107 of the addition of the new network interface unit 102 associated with that subscriber. Upon receipt of such notification, the operational support system 107 automatically provisions a “soft” dial tone to the network interface unit 102. The soft dial tone allows calls to “911” or to the IVR 108. The installation technician calls the IVR 108 using a telephone or butt set and keys-in the work order number. The IVR 108, using calling number delivery (Caller ID, for example) references the provisioning records and identifies the network interface unit 101. The operational support system 107 removes the soft dial tone and completes the service delivery by provisioning all ordered lines and features.

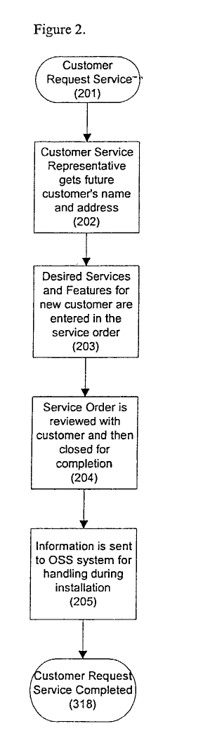

Referring now to FIG. 2, there is shown flowchart illustrating the logical steps in customer request service process. The process begins with the potential subscriber (customer) requesting service, Step 201. A customer service representative obtains is the potential subscriber's name and address Step 202 and information as to the type of service and features the subscriber desires and enters the information in a service order Step 203. The service order is reviewed with the subscriber and then closed, Step 204. This information is then inputted into the operational support system 107 for use during installation, Step 205 and the process is completed, Step 206.

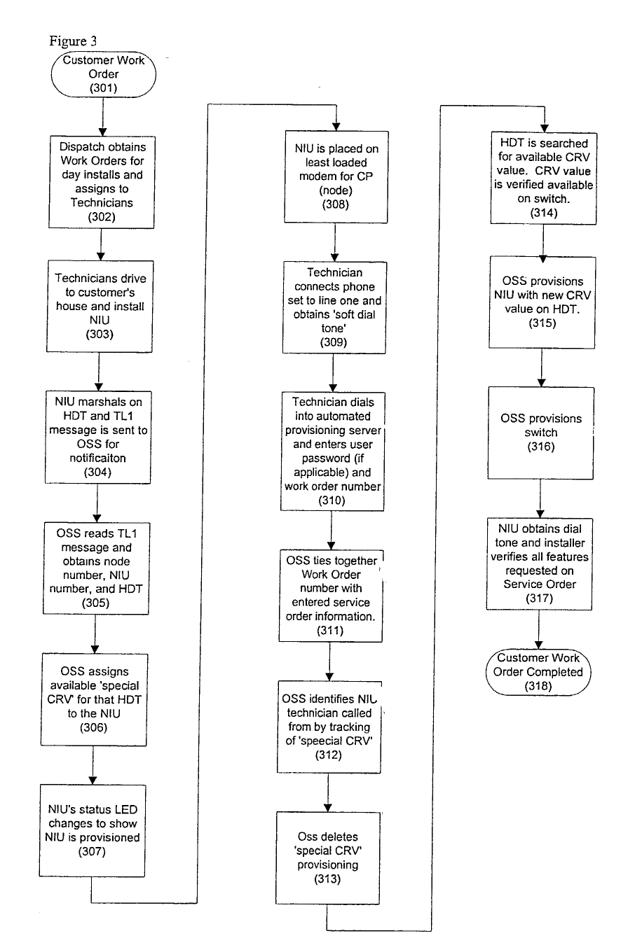

Referring now to FIG. 3, there is shown a flowchart illustrating the logical steps of an embodiment of the auto-discovery provisioning method of the present invention. A work order is developed from the service order produced in the process shown in FIG. 2, Step 301. The dispatch department obtains the work order for the installation work to be done that day and assigns a technician to performed the installation, Step 302. The technician travels to the subscriber's premises 103 and installs the network interface unit 102 for that subscriber, Step 303. The network interface unit 102 marshals on the host digital terminal 104 to which the network interface unit 102 is connected by sending a message to the host digital terminal 104 containing a unique identification number (electronic serial number) for that network interface unit 102. The element management system 106 then sends a message formatted in Transaction Language 1 (“TL1”) to the operational support system 107, Step 304. The element management system 106 controls and facilitates the messaging between the different components of the broadband communications network 100. The message may be sent at certain intervals, such as every 5 minutes, in case the system is busy or the message is lost. The operational support system 107 reads the message and obtains node number, electronic serial number, and the host digital terminal 104, Step 305. The operational support system 107 then assigns an available special call-reference-value (“CRV”) for that network interface unit 102 to host digital terminal 104, Step 306. The special CRV correlates the electronic serial number to a directory number and provides a “soft” dial tone. The soft dial tone only allows calls to “911” or IVR 108. The operational support system 107 may buffer the electronic serial number if no special CRV is available at the time and then check at certain intervals, such as every minute, for the available unit to provision. Status lights on the network interface unit 102 may change to give a visual indication that the network interface unit 102 has been identified by the operational support system 107 and that a special CRV was assigned, Step 307.

The operational support system 107 places the network interface unit 102 on the least loaded modem at the node, Step 308. The technician connects a phone set to line 1 on the network interface unit 102 and obtains the soft dial tone at Step 309. The technician accesses the IVR 108 and enters the subscriber's password (if required by the operator) and work order number, Step 310. Operational support system 107 compares work order number with service order entered into IVR 108 as shown in FIG. 2, Step 311. The particular network interface unit 102 from which the technician is calling is identified by the special CRV, Step 312. Operational support system 107 then deletes the special CRV from the network interface unit 102 at Step 313 and searches the host digital terminal 104 for an available CRV and verifies that it is on the switch 110 at Step 314. The operational support system 107 then provisions the network interface unit 102 with the new, permanent, CRV on the host digital terminal 104 via TL1 messaging at Step 315. The operational support system 317 then provisions switch 110 at Step 317. Network interface unit 102 obtains the dial tone and the technician verifies all features requested on the service order at Step 317 and the process is complete at Step 318.

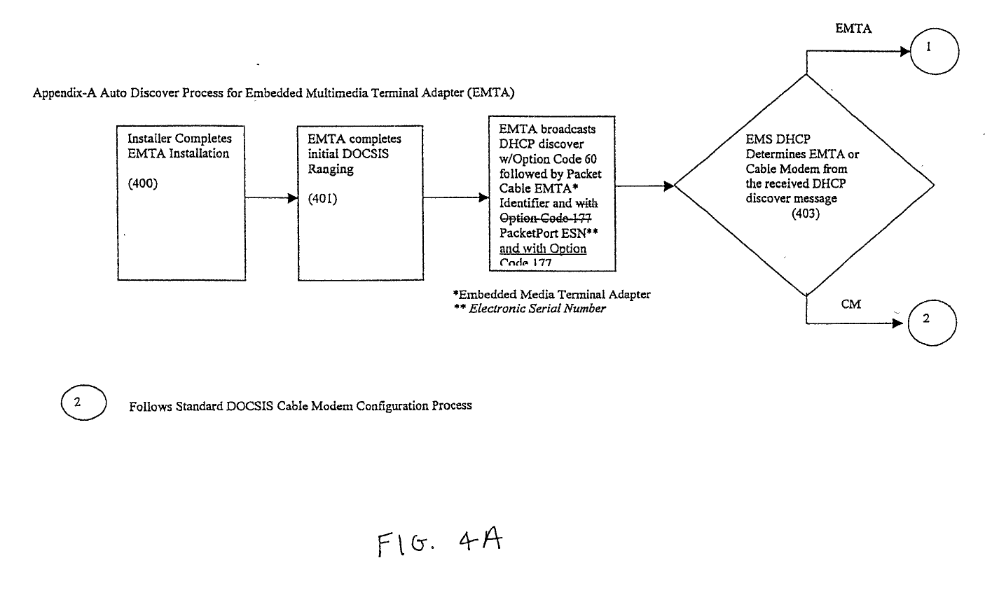

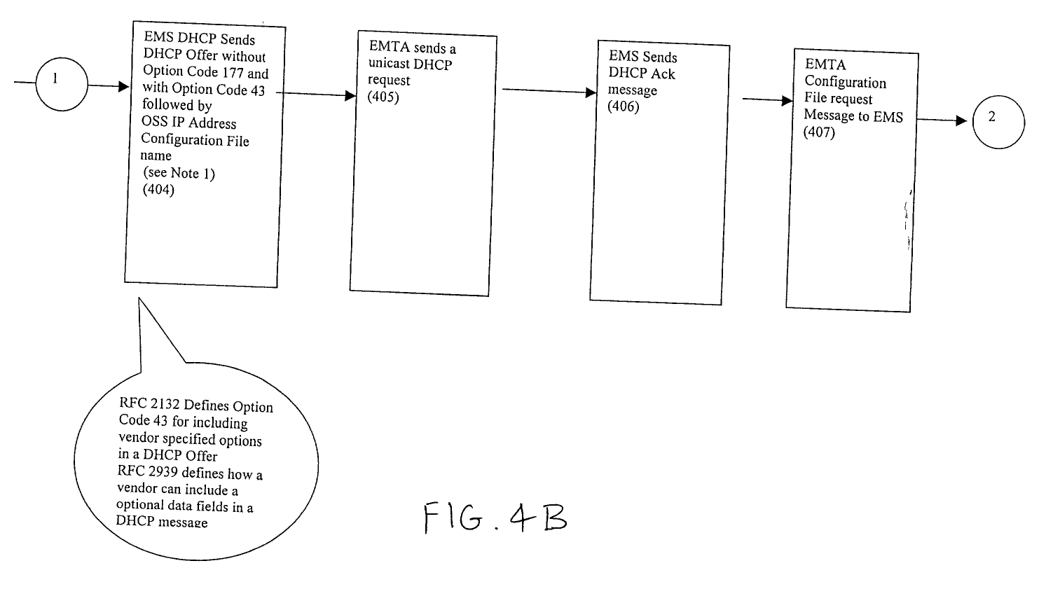

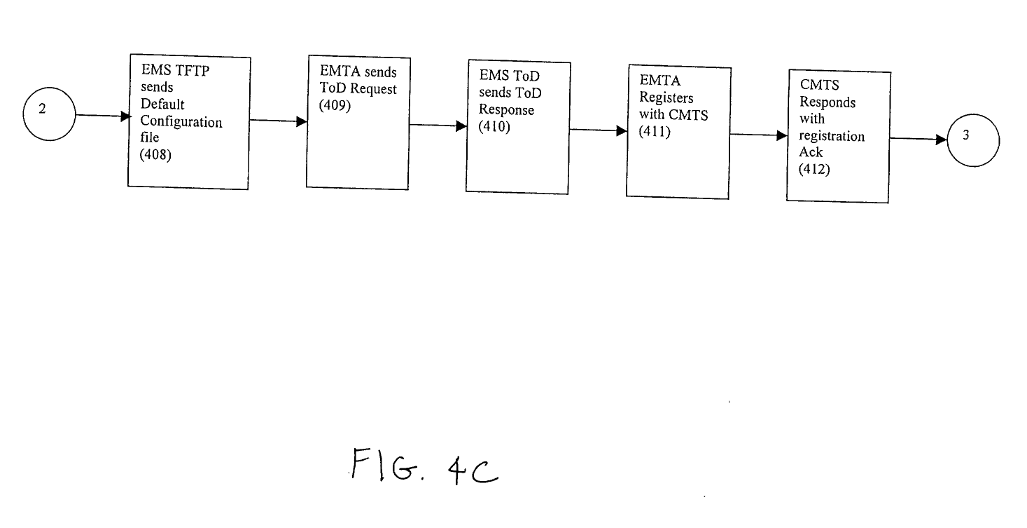

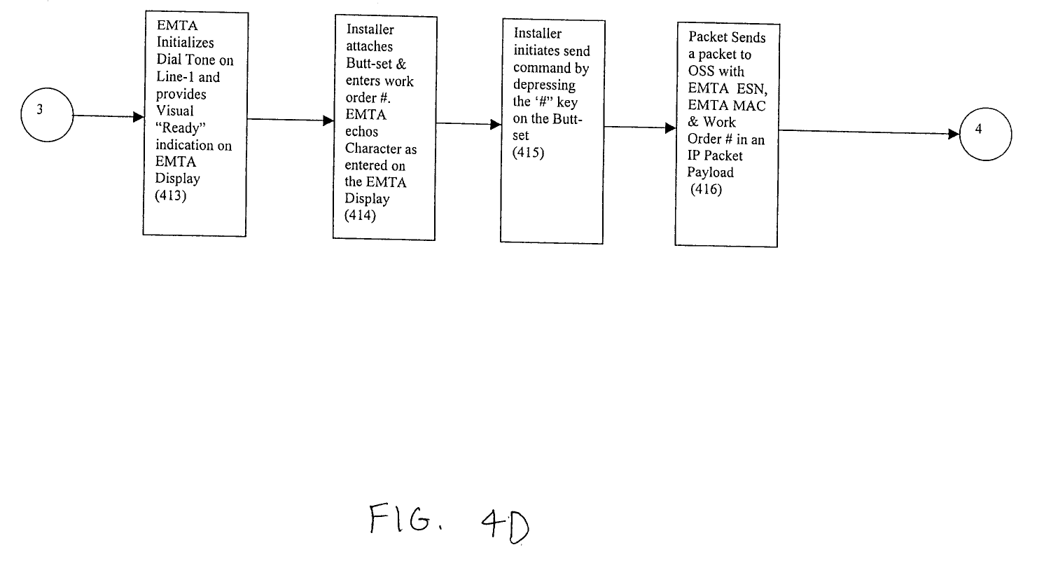

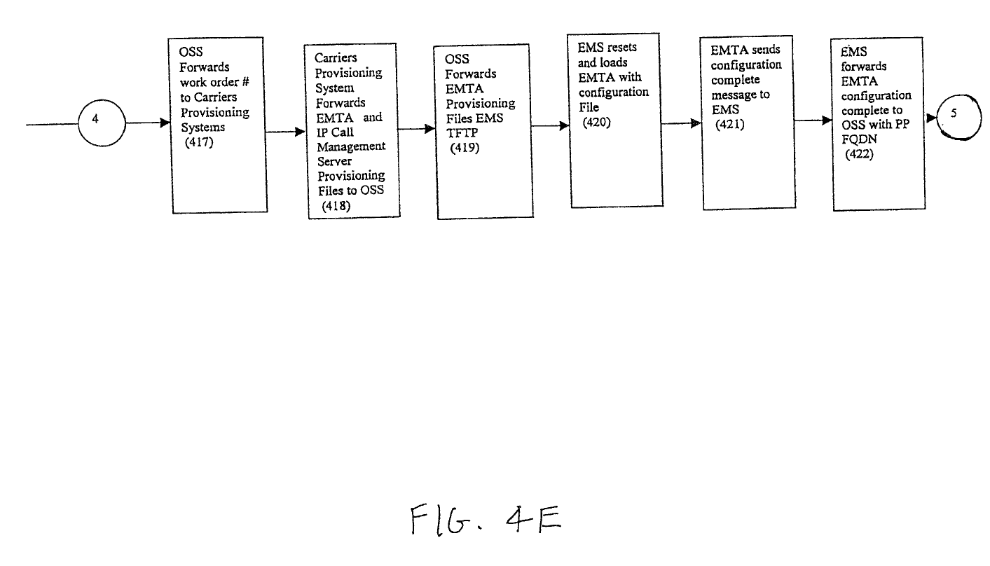

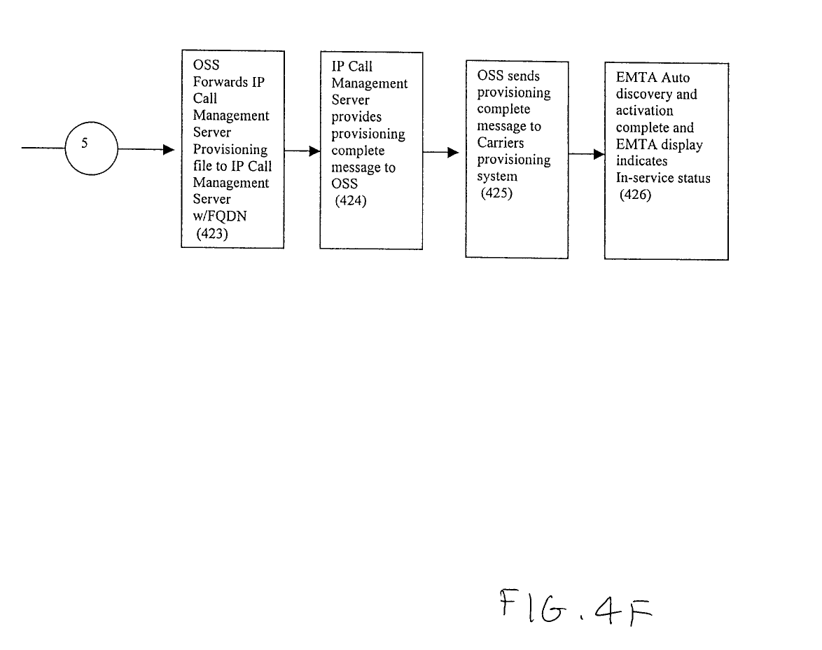

Referring now to FIGS. 4A, 4B, 4C, 4D, 4E and 4F, there is shown a flowchart illustrating the logical steps of another embodiment of the autodiscovery provisioning method of the present invention FIGS. 4A-4F illustrate the auto-discovery provisioning method as applied to an Embedded Multimedia Terminal Adapter (EMTA) and a CMTS 113 employing Data Over Cable System Interface Specification (“DOCSIS”) protocol. The EMTA is installed, Step 400, and completes DOCSIS initial ranging, Step 401. The EMTA then broadcasts Dynamic Host Configuration Protocol (“DHCP”) Discover with Option Code 60 followed by the unique device identifier as well as a request for option code 177, Step 401. The element management system 106 determines if the network interface unit 102 is an EMTA or a Cable Modem, Step 403. If it is an EMTA, the element management system DHCP sends DHCP Offer without Option Code 177 and with Option Code 43 followed by ADP IP address, Step 404, Step 404. Internet Engineering Task Force (IETF) Request for Comment (RFC) 2132 defines option code 43 for vendor option in DHCP offer and MTF RFC 2039 details vendor defined DHCP message options. EMTA sends a unicast DHCP request to the element management system DHCP, Step 405. The element management system responds with a DHCP Acknowledge (“ACK”), STEP 406. The EMTA then sends a DOCSIS configuration file request to the element management system, Step 407. The element management system sends the DOCSIS default configuration file, Step 408. The EMTA sends Time of Day (ToD) request, Step 409, and the element management system sends a ToD response, Step 410. The EMTA then registers with the CMTS, Step 411, and the CMTS responds with a Registration ACK, Step 412. The MTA initializes local dialtone on Line 1 and provides a visual “ready” indication on the EMTA display, Step 413. The installation technician attaches a butt-set to the EMTA. The installation technician enters the work order number and the EMTA echoes characters as shown on the EMTA display, Step 414. The installation technician initiates the send command by pressing the “#” key on the butt-set, Step 415. The EMTA then sends a message, Step 416, to the operational support system. The message is a packet containing the EMTA's electronic serial number, MAC and the work order number in its payload, Step 416. The operational support system forwards the work order number to the service provider's provisioning system, Step 417. The service provider's provisioning system forwards the EMTA provisioning information to the operational support system, Step 418, which forwards it to the element management system, Step 419. The element management system resets and loads the EMTA provisioning information, Step 420. The EMTA then sends a provisioning complete message to the element management system, Step 421. The element management system forwards the EMTA provisioning complete message to the operational support system with the rally qualified domain name (FQDN) for the EMTA, Step 422. The operational support system forwards the telephony-provisioning file to the Call Management Server (CMS) 114, Step 423. The CMS 114 sends a provisioning complete file to the operational support system, Step 424. The operational support system then sends the provisioning complete message to the service provider's provisioning system, Step 425, which completes the EMTA provisioning and service activation process, Step 426.

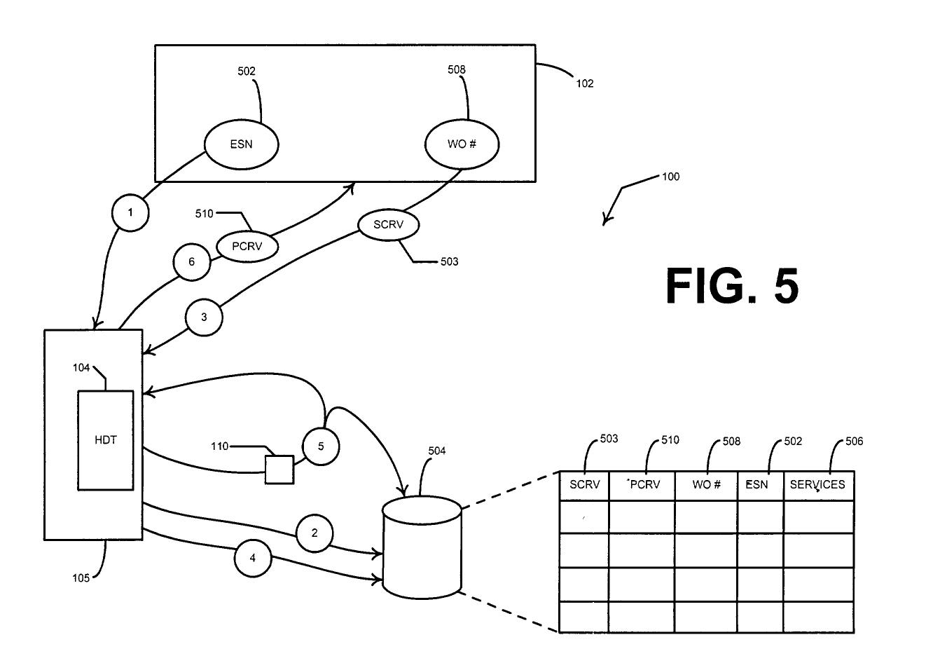

Turning now to FIG. 5, a simplified block diagram of network 100 illustrates the flow and temporal relationship of information messages that implement the automatic telephony provisioning aspects. Upon installation and connection of network interface unit 102 in network 100, a message packet comprising the electronic serial number 502 of the network interface unit is transmitted upstream to the network operator's facility 105 at step 1 using detection methods known in the art. The sending of the electronic serial number 502 initiates the creation of the special CRV 503 and soft dial tone service to network interface unit 102. When the special CRV 503 has been generated and associated with the electronic serial number 502 of network interface unit 102, these data are recorded at step 2 in database 504. Database 504 is part of operator facilities 105 and associates the ordered services 506 with the work order number 508 corresponding to the ordered services that were previously recorded when the service order was received from the subscriber.

When the field technician confirms that the electronic serial number message 502 has been received at operator facilities 105 and that soft dial tone has been established, the technician enters the work order number 508 from the network interface unit 102 at step 3 using the telephone keypad, voice input or other methods known in the art. Since the work order number message 508 is received using the same special CRV 503 that was associated with electronic serial number 502 of network interface unit 102 at step 2, and because the work order number 508 corresponds to the ordered services, equipment at operator facilities 105 can associate the ordered services with the corresponding network interface unit at step 4. In addition, the host digital terminal may return a validation message, such as an audible tone or a ring back message, to the network interface unit 102, so that the field technician can confirm that a valid work order number was entered. Then, the operator's facilities 105 can determine a permanent CRV 510, based on criteria from network switch 110. The special CRV 503 is replaced with the permanent CRV 510 so that the soft dial tone functionality to the network interface unit 102 is replaced with the ordered services at step 6. Thus, auto-detection of electronic serial number 502 of network interface unit 102 may be used in conjunction with special CRV 503 to reduce the amount of data entry that is required of the field technician, thus reducing the possibility of error in provisioning the newly installed network interface unit.

What is claimed is:

1. A method for automatically provisioning requested services from a service order to a subscriber network interface unit having a unique electronic identifier in a broadband communications network having one or more network interface units, the requested services being associated with a work order having a corresponding work order number, comprising:
sending the unique electronic identifier from the network interface unit to a host digital terminal;
associating a special call reference value assigned to a soft dial tone channel with the unique electronic identifier;
transmitting the work order number from the network interface unit over the soft dial tone channel;
associating the work order number with the network interface unit based on the special call reference value; and
replacing the special call reference value with a permanent call reference value.

2. The method of claim 1 further comprising provisioning a network switch with the requested services to be associated with the permanent call reference value.

3. The method of claim 1 wherein the step of transmitting includes transmitting a password along with the transmitting of the work order number.

4. The method of claim 1 further comprising the step of validating the work order number at the network interface unit.

5. The method of claim 4 wherein the step of validating the work order number includes providing an audible validation tone to the network interface unit upon correctly transmitting the work order number.

6. The method of claim 4 wherein the step of validating the work order number includes providing a ring-back signal to the network interface unit and re-transmitting of the work order number.

7. The method of claim 1 further comprising the step of illuminating a status light on the network interface unit indicating that the soft dial tone signal has been established and the special call reference value has been associated with the network interface unit.

8. A method for automatically provisioning requested services from a service order to a subscriber network interface unit having a unique electronic identifier in a broadband communications network having one or more network interface units comprising:
associating the requested services with a work order having a corresponding work order number;
provisioning a network switch with the requested services;
sending the unique electronic identifier from the network interface unit to a host digital terminal;
associating a special call reference value assigned to a soft dial tone channel with the unique electronic identifier;
transmitting the work order number from the network interface unit over the soft dial tone channel;
identifying the network interface unit based on the special call reference value;
replacing the special call reference value with a permanent call reference value; and
associating the requested services associated with the work order with the network interface unit based on the special call reference value.

9. The method of claim 8 further comprising provisioning a network switch with the requested services to be associated with the permanent call reference value.

10. The method of claim 8 wherein the step of transmitting includes transmitting a password along with the transmitting of the work order number.

11. The method of claim 8 further comprising the step of validating the work order number at the network interface unit.

12. The method of claim 11 wherein the step of validating the work order number includes providing an audible validation tone to the network interface unit upon correctly transmitting the work order number.

13. The method of claim 11 wherein the step of validating the work order number includes providing a ring-back signal to the network interface unit and re-transmitting of the work order number.

14. The method of claim 8 further comprising the step of illuminating a status light on the network interface unit indicating that the soft dial tone signal has been established and the special call reference value has been associated with the network interface unit.
